(19) United States
(12) Patent Application Publication
(10) Pub. No.: US 2009/0122566 A1
(43) Pub. Date: May 14, 2009

(54) Vehicle tail light assembly and method of use

(76) Inventor: Glen Cunningham, Oakland Park, FL (US)

Correspondence Address: MELVIN K. SILVERMAN AND ASSOCS PC, 500 WEST CYPRESS CREEK ROAD, SUITE 350, FT. LAUDERDALE, FL, 33309, US

(21) Appl. No.: 11/985,013

(22) Filed: Nov. 13, 2007

(51) Int. Cl. B60Q 1/00

(52) U.S. Cl. 362/487

(57) ABSTRACT

A tail light assembly includes a plurality of tail lights having substantially same appearance affixed on the rear light panel of a vehicle and the assembly is electrically connected to the rear light control of the vehicle. Each of the tail lights includes an open housing having a reflective chrome interior surface and an axially disposed light bulb socket at a rear end of the surface; a colorless LED light bulb disposed in the light bulb socket; and a clear colorless front cover affixed upon a front perimeter of the housing. When the tail lights are not activated, the plurality of tail lights have a uniform chrome appearance, and when being activated, one or more tail lights emits a colored light substantially different from the chrome appearance, to indicate braking, turning or backing up of the vehicle.

### FIELD OF THE INVENTION

The present invention relates to a tail light assembly for vehicles, and more particularly to a tail light assembly for trucks and trailers and method of use.

### BACKGROUND OF THE INVENTION

Various tail lights have been used for trucks, trailers, motorcycles, cars and other vehicles. The existing tail lights typically have an incandescent light bulb mounted within a light housing which is covered by a reflective and colored cover. When the light bulb is activated, the tail light lights up with a color, such as red, yellow or white, to provide a desired signal.

Recently, light emitting diode (LED) assemblies have been used in tail lights in place of traditional incandescent light bulbs. LED light uses less power and has longer life than the traditional incandescent light bulbs, and it can also provide appealing decorative lighting patterns.

U.S. Pat. No. 5,947,588 (to Huang) discloses an automobile lamp including an LED light element connected to an existing incandescent-style mounting location. U.S. Pat. No. 6,357,902 (to Horowitz) discloses a LED assembly designed to be used in a tail light or turn indicator assembly, wherein a plurality of LEDs are mounted upon a single circuit board that may be arranged in numerous colors, patterns and shapes.

U.S. Pat. No. 6,793,384 (to Ban et al.) discloses the use of LEDs in a tail lamp structure for motorcycles, in which a tail lamp and a brake lamp are made up of an array of a plurality of LED's. U.S. Pat. No. 6,840,654 (to Guerrieri et al.) discloses an LED light bulb with a reflector that retains a plurality of LEDs. The reflector is constructed using a cone shaped housing and the reflecting surface is adapted to receive each LED with a chamber constructed therefore.

Recently, a combination of a chrome housing surface and a reflective colorless cover has been used for tail light assembly of vehicle. In such an assembly, several uncolored incandescent light bulbs are used; each of them is surrounded by a colored chamber. When a light bulb is on, the light emits through the colored chamber to provide a desired color signal. Since the cover of the tail light has reflective patterns, the interior structure of the tail light including the chrome surface is not visible from the outside. This type of tail light design provides appealing chrome appearance from distance, however, it also inheres the disadvantages of the traditional incandescent light bulbs. Moreover, the chrome housing surface is not used to reflect the light coming from the headlights of a vehicle behind.

Therefore, it is desirable to provide improved tail light structures which utilizes the advantages of LED light, offers decorative features to the vehicles and enhances safety measure of the vehicles.

### SUMMARY OF THE INVENTION

In one aspect, the present invention is directed to a tail light for a vehicle, which comprises an open housing having a reflective chrome interior surface, a front perimeter and an axially disposed light bulb socket at a rear end of the surface; a colorless LED light bulb disposed in the light bulb socket; the LED light bulb emitting white, yellow, or red light when being activated; and a clear colorless front cover affixed upon the front perimeter of the housing.

In a further aspect, the present invention is directed to a tail light assembly for a vehicle. The tail light assembly comprises a plurality of tail lights having substantially same appearance affixed on a rear light panel of a vehicle, the tail light assembly electrically connected to a rear light control of the vehicle. Each of the tail lights comprises an open housing having a reflective chrome interior surface, a front perimeter and a light bulb socket disposed at a rear end of the surface; a colorless LED light bulb disposed in the light bulb socket; and a clear colorless front cover affixed upon the front perimeter of the housing. When the tail lights are not activated, the plurality of tail lights have a uniform chrome appearance; and when being activated, one or more tail lights emits a colored light substantially different from the chrome appearance, to indicate braking, turning or backing up of the vehicle.

The advantages of the present invention will become apparent from the following description taken in conjunction with the accompanying drawings showing exemplary embodiments of the invention.

### BRIEF DESCRIPTION OF THE DRAWINGS

FIG. 1 illustrates a tail light assembly of the present invention installed on the rear light panel of a truck.

FIG. 2 is a partial cut-away perspective view of a tail light of the tail light assembly of the present invention, having half of the front cover removed to show the interior of the housing.

FIG. 3 is a partial cut-away exploded view of the tail light of FIG. 2.

FIG. 4 is a cut-away side view of the tail light of FIG. 2, with the housing cut along line 2-2 of FIG. 2.

FIG. 5 is a partially cut rear perspective view of the tail light of FIG. 2.

FIG. 6 is an illustrative view of the tail light assembly in one embodiment of the present invention.

FIG. 7 is a close front view on one side of the tail light assembly of FIG. 1.

FIG. 8 shows an alternative shape of the tail lights of the tail light assembly of the present invention installed on the rear light panel of a truck.

It is noted that in the drawings like numerals refer to like components.

### DETAILED DESCRIPTION OF THE INVENTION

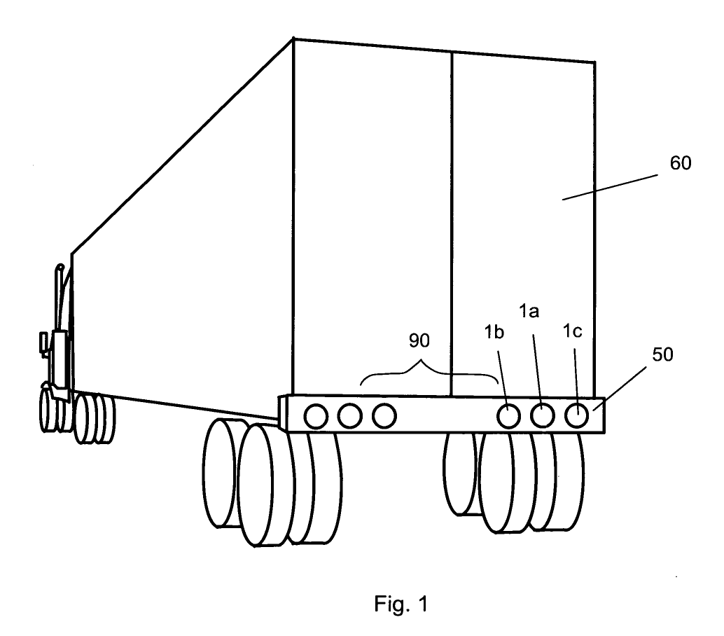

In one embodiment, the present invention provides a tail light for vehicles, particularly for trucks and trailers as shown in FIG. 1.

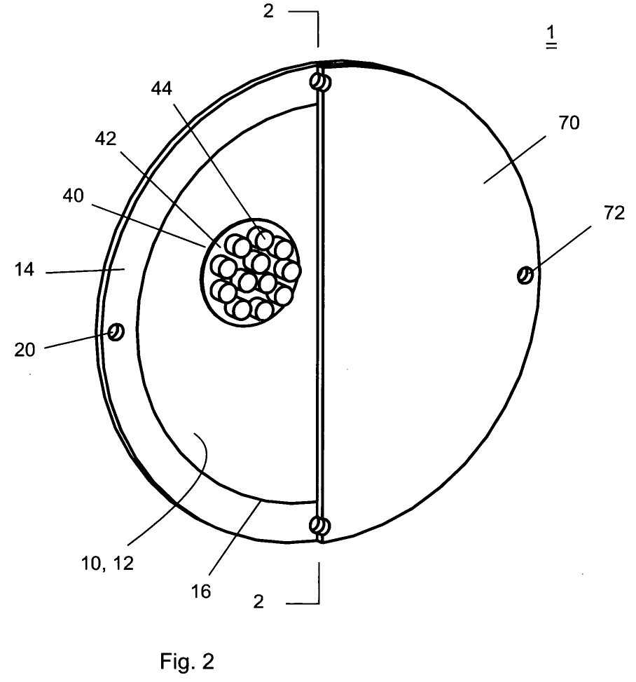

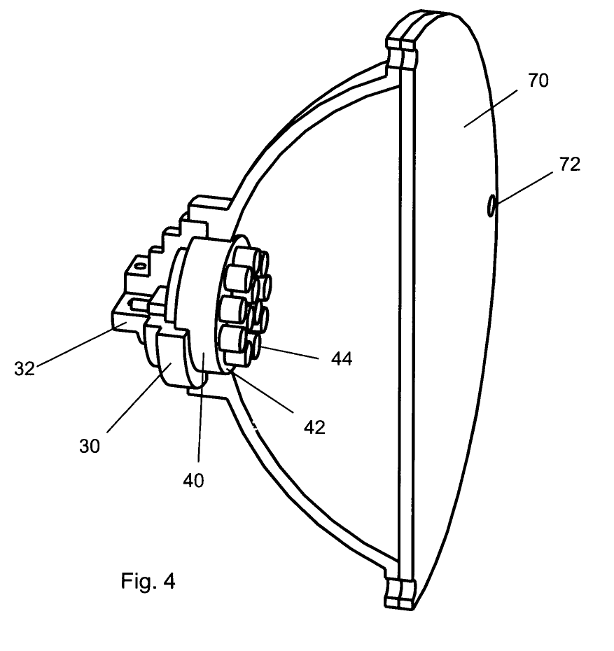

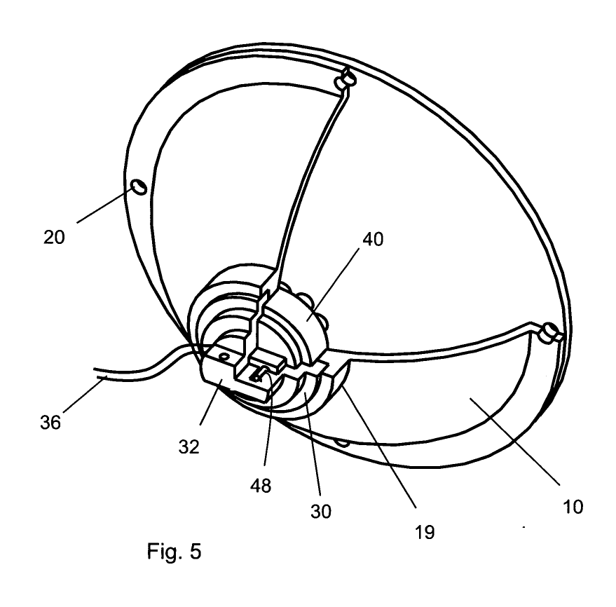

As shown in FIGS. 2-5, tail light 1 comprises an open housing 10, a LED light bulb 40 and a clear colorless front cover 70.

In the embodiment illustrated in FIGS. 2-5, the open housing has a reflective, chrome interior surface 12, a front perimeter 14, and a light bulb socket 30 axially disposed at the rear end 18 of the surface 12. The term “chrome” used herein refers to chromium plated surface or other bright metallic coating having an appearance of metal chromium, without tainted with colors.

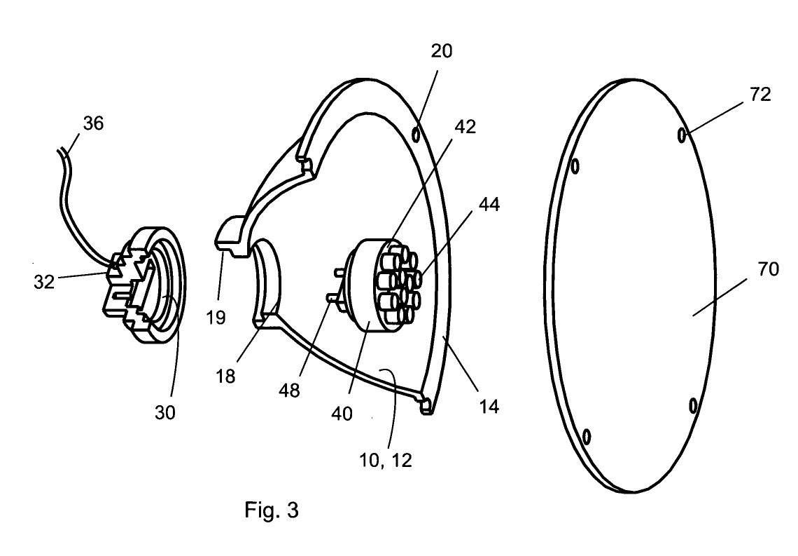

The open housing 10 defines substantially a concave volume. In the embodiment shown in FIGS. 2-5, open housing 10 is parabolic and the front opening is circular. The housing 10 can typically have a circular front opening with a width about 10 centimeters, which can fit into the exiting rear light panels of trucks and trailers. However, other sizes can also be used. Front perimeter 14 can have a width of about 0.5 to about 2 centimeters, and preferably also has a chrome surface. Front perimeter 14 includes a plurality of apertures 20 for securing the tail light on to rear light panel 50 of a truck or trailer (see FIG. 1) As shown in FIG. 3, housing 10 has a base 19 as a seating interface with light bulb socket 30. In the embodiment shown, base 19 has a smooth interface for engaging with a smooth external surface of light bulb socket 30. The connection can be further secured by suitable mechanical means, or by adhesive. Alternatively, a threaded seating interface 19 can be provided for a thread connection with light bulb socket 30.

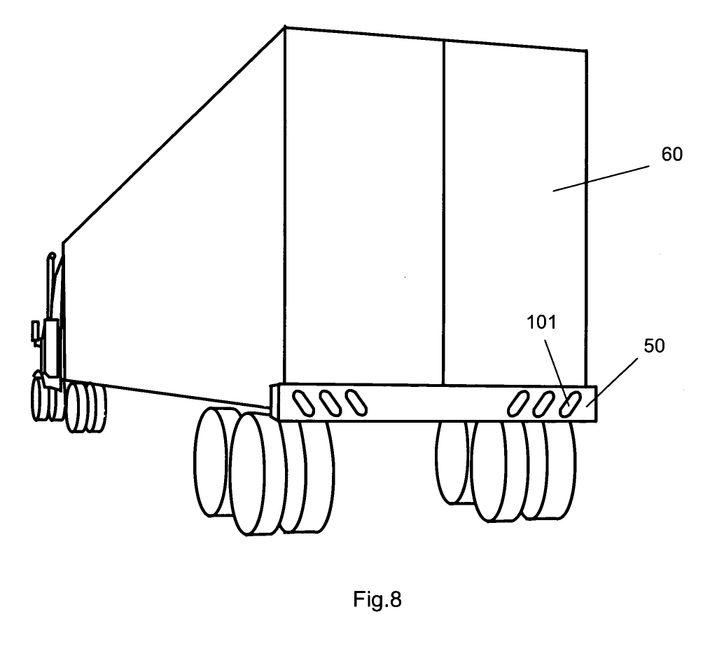

In the embodiment shown in FIGS. 2-5, tail light is circular. However, it should be understood that the housing and hence the tail light can have any suitable shape for a particular model of a vehicle, such as oval shape tail lights 101 shown in FIG. 8.

The interior surface 12 of housing 10 is highly reflective, which reflects the light emitted from the LED light bulb 40 through front cover 70 to the rear direction of the vehicle. The interior surface 12 can be produced with the materials and methods known in the art.

The front cover 70 is secured on to housing 10. In the embodiment shown FIGS. 2-5, front cover 70 has a plurality of spaced apart apertures 72 adjacent to the periphery of the cover, corresponding to the locations of apertures 20 of front perimeter 14 of housing 10. When being installed, front cover 70 and housing 10 can be secured on to the real light panel by screws or other suitable fasten means through apertures 72 and 20.

In an alternative embodiment, front perimeter 14 can be attached to front cover 70 using clips or snapping means known in the art. Moreover, front cover 70 can also be attached to front perimeter 14 of housing 10 by adhesive, such as epoxy or other suitable bonding agents.

Preferably, front cover 70 is non-reflective and substantially flat, as such, the light emitted by LED light bulb 40 is reflected by the reflective chrome interior surface 12 and emitted through the clear front cover 70 toward the rear direction of the vehicle. On the other hand, since front cover 70 is flat and non-reflective, when another vehicle approaches closely to the rear end of the vehicle installed with the instant tail light assembly, the light emitted from the head lights of the other vehicle will be reflected by the interior surface 12 of tail light 10, and which will alert the driver in the other vehicle to maintain a proper distance. Currently, various existing tail lights have a reflective front cover to cause reflection of light coming from the vehicle behind and provide decorative features. In the tail light assembly of the present invention, the reflective chrome interior surfaces 12 of multiple tail lights 1 on the rear light panel of the vehicle not only provide a decorative uniform metallic appearance, they generate sufficient reflections of light coming from the vehicle behind, which is a property required for tail lights for transportation safety, particularly for driving in the night.

Preferably, LED light bulb 40 has a clear and colorless appearance. LED light bulbs suitable for vehicles are commercially available from various sources. LED light bulb has high luminance and efficiency, and it is small in size, can emit bright color light. As a semiconductor element, it is not vulnerable to breakage. Also, the LED light bulb has excellent initial driving characteristics and vibration resistance and can withstand repeated ON/OFF cycling and is therefore suitable as a light source in automotive vehicles. The LED light bulbs described herein are high brightness LED.

In the embodiment shown in FIG. 3, a clear and colorless LED light bulb 40 from American Products Company (Corona, Calif.) is used in tail light 1. As shown, LED light bulb 40 includes a plurality of protruding LED elements 44 on the front surface 42 arranged in a circular pattern. Each LED element is attached to a circuit board within the LED light bulb 40. The protruding LED elements 44 and front surface 42 are clear and colorless, and preferably behind the clear and colorless front surface 42 is a white background for blending the light bulb into the surrounding chrome surface. Typically, the diameter of LED light bulb 40 is substantially smaller than the diameter or width of housing 10 at front opening 16. For example, the LED light bulb shown in FIG. 2 has a diameter about 2.5 to 3.0 centimeters, and the diameter of housing at front opening 16 is about 10 centimeters. Because of the reflective feature of the interior chrome surface 12 and clear colorless appearance of the LED light bulb, under the regular day light the LED light bulb is less visible comparing to the surrounding chrome surface, which offers tail light 1 an uniform chrome appearance.

These clear and colorless LED light bulbs can emit different color lights when being powered. For the purpose of tail light for vehicles, only three colors are desirable, i.e., white, yellow and red. For simplicity and low cost, the commercially available LED light bulbs enabling emission of one single color are used for the instant tail light. The tail lights incorporating these clear and colorless LED light bulbs can be coded depending on the emitted light color of a specific LED light bulb. In other words, when the tail lights are not powered, all LED light bulbs have same clear colorless appearance and all tail lights have the same chrome appearance. Once they are powered electrically, the tail lights emit white, yellow, or red colored light, depending on the specific LED light bulb used. Alternatively, a LED light bulb that enables emission of multiple different colors when being activated selectively can also be used for the purpose of the present invention.

The term clear used herein means transparent and capable of transmitting light. Further, the terms clear and transparent are used interchangeably herein. The term red light is a light with a wavelength between about 630 nm to about 700 nm; yellow light is a light with a wavelength between about 560 nm to about 590 nm; and white light is a light that is a mixture of all colors of light in the visible light spectrum from about 380 nm to about 740 nm.

As shown in FIG. 3, LED light bulb 40 has legs 48 for plugging into light bulb socket 30. The rear side 32 of light bulb socket 30 includes a connection interface 36, for example in the form of wires, for connection with a power supply and to the rear light control of the vehicle.

In the embodiment shown, the LED light bulb and light bulb socket 30 are provided near the focal point of the parabolic interior surface 12 of housing 10 to facilitate uniformed light reflection. However, LED light bulb, and hence, light bulb socket 30 can also be positioned at other areas within housing 10.

In a further embodiment, the present invention provides a tail light assembly for vehicles, particularly for trucks and trailers, as illustrated in FIGS. 1, 6 and 8.

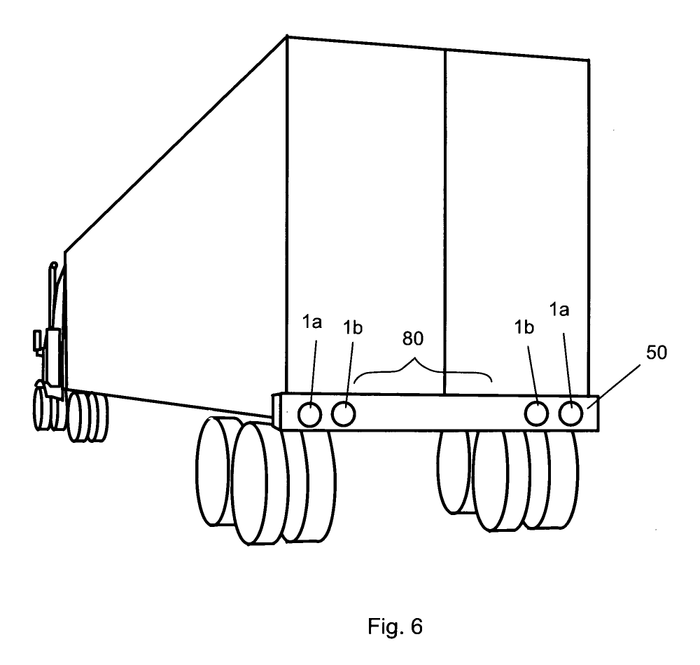

FIG. 6 shows a tail light assembly 80 of the present invention, which comprises a plurality of tail lights 1 that have substantially the same appearance affixed on rear light panel 50 of a vehicle. In the embodiment shown in FIG. 6, tail light assembly 80 includes four tail lights 1, two on each side of real light panel 50. FIG. 1 shows another tail light assembly 90 of the present invention, which includes six tail lights 1, three on each side of real light panel 50. Although the external appearance of the tail lights is the same, they emit different light when being activated.

The color arrangement of the tail lights within the tail light assembly is symmetric. As illustrated in FIG. 6, in one example arrangement of tail light assembly 80, one tail light 1a, which emits a red light when being activated, is installed on each side and at the outmost of rear light panel 50; and one tail light 1b, which emits a white light when being activated, is installed on each side and at the inner side of tail light 1a. As illustrated in FIG. 1, in one example arrangement of tail light assembly 90, one tail light 1c, which emits a yellow light when being activated, is installed on each side and at the outmost of rear light panel 50; and one tail light 1a, which emits a red light when being activated, is installed on each side and at the inner side of tail light 1c; and one tail light 1b, which emits a white light when being activated, is installed on each side and at the inner side of tail light 1a.

The tail light assembly is electrically connected to the existing rear light control of a vehicle. The rear light control selectively activates the LED light bulbs 40 to indicate turning, braking, or backing up of the vehicle. When single color LED light bulbs are used in the assembly, the selective activation is given to different tail lights, as each tail light emits only one color. When multi-color LED light bulbs are used in the assembly, the selective activation is given to one or more tail lights to selectively active a specific color mode.

The operating mechanism of tail light assemblies 80 and 90 can be further described with reference to FIGS. 6, 1 and 7, respectively. As described above, tail light assembly 80 includes four tail lights, with one tail light 1a (emitting red light) at the outmost of the rear light panel 50 on each side, and with one tail light 1b (emitting white light) at the inner side of tail light 1a on each side. When the vehicle is braking, the rear light control activates the two tail lights 1a to provide a red light braking signal. When the vehicle is backing up, the rear light control activates the two tail lights 1b to provide a white light backing up signal. When the driver wants to indicate a left or a right turn, the rear light control activates one tail light 1a to provide blinking red light turning signals, or alternatively activate one tail light 1b to provide blinking white light turning signals.

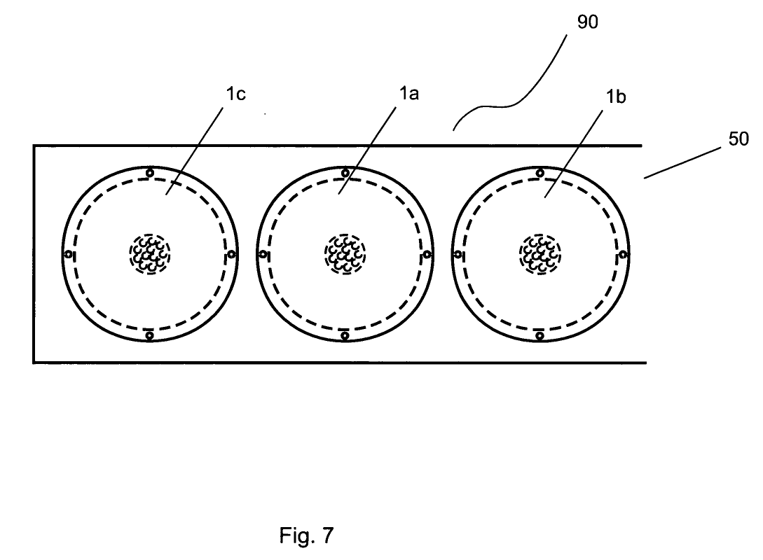

In tail light assembly 90, there are six tail lights, three on each side. As shown in FIGS. 1 and 7, tail lights 1c, 1a and 1b are arranged from the outmost to the inner side of the rear light panel 50. Similar to tail light assembly 80, when the vehicle is braking, the rear light control activates the two tail lights 1a to provide a red light braking signal, and when the vehicle is backing up, the rear light control activates the two tail lights 1b to provide a white light backing up signal. In this case, when the driver wants to indicate a left or a right turn, the rear light control activates one tail light 1c to provide blinking yellow light turning signals.

As it can be appreciated because all LED light bulbs 40 have the same clear colorless appearance, all tail lights in tail light assembly 80 or 90 have a uniform chrome appearance when they are not activated. When the tail light assembly is activated by the real light control of the vehicle to indicate a braking, turning or backing-up of the vehicle, one or more of these tail lights emit a light substantially different from the unlit chrome appearance, which results in a striking color change.

When the tail lights are activated, the visual effect of the colored light against the uncolored chrome surface is striking and dramatic. Therefore, the tail light assembly of the present invention provides an eye catching light signal to indicate a braking, backing-up or turning mode of the vehicle.

Different from the prior art tail light, which typically includes different compartments, each having a reflective colored cover and an incandescent light bulb installed within, which emits white light. When the incandescent light is activated, the colored cover is lit up to provide a color signal. Therefore, the signal involves a change of the brightness of an existing color, but not a change of the color itself. In contrast, using the tail light assembly of the present invention, the signal involves both a change of the brightness and a change of the color from the uncolored chrome surface to a bright red, yellow or white color. Therefore, the instant tail light assembly generates a more drastic visual effect in the signals, which provides a safety improvement to the vehicles.

Additionally, the unique uniform chrome appearance of the tail light assembly of the present invention also provides a decorative feature to the vehicles.

The invention has thus been described with reference to particularly preferred embodiments. It will be appreciated, however, that various changes can be made without departing from the spirit of the invention, and such changes are intended to fall within the scope of the appended claims. While the present invention has been described in detail and pictorially shown in the accompanying drawings, these should not be construed as limitations on the scope of the present invention, but rather as an exemplification of preferred embodiments thereof. It will be apparent, however, that various modifications and changes can be made within the spirit and the scope of this invention as described in the above specification and defined in the appended claims and their legal equivalents. All patents and other publications cited herein are expressly incorporated by reference.

I claim:

1. A tail light for a vehicle comprising:
(a) an open housing having a reflective chrome interior surface, a front perimeter and a light bulb socket disposed at a rear end of said surface;
(b) a colorless LED light bulb disposed in the light bulb socket; the LED light bulb emitting white, yellow, or red light when being activated; and
(c) a clear colorless front cover affixed upon said front perimeter of said housing.

2. The tail light of claim 1, wherein said front cover is substantially flat.

3. The tail light of claim 2, wherein said front cover is non-reflective.

4. The tail light of claim 3, wherein a rear side of said light bulb socket comprises a connection interface for connecting to a power supply and to a rear light control of a vehicle.

5. The tail light of claim 4, wherein said housing defines substantially a concave volume and said front perimeter thereof is circular.

6. A tail light assembly for a vehicle comprising a plurality of tail lights having substantially same appearance affixed on a rear light panel of a vehicle, said tail light assembly electrically connected to a rear light control of said vehicle; each of said tail lights comprising:
(a) an open housing having a reflective chrome interior surface, a front perimeter and a light bulb socket disposed at a rear end of said surface;
(b) a colorless LED light bulb disposed in the light bulb socket; and
(c) a clear colorless front cover affixed upon said front perimeter of said housing;
wherein when not activated, said plurality of tail lights have a uniform chrome appearance, and when being activated to indicate braking, turning or backing up of said vehicle, at least one of said plurality of tail lights emits a light causing said at least one tail light substantially different from said chrome appearance.

7. The tail light assembly of claim 6, wherein said front cover of each of said tail lights is substantially flat.

8. The tail light assembly of claim 7, wherein said front cover of each of said tail lights is non-reflective.

9. The tail light assembly of claim 8, wherein a rear side of said light bulb socket comprises a connection interface for connecting to a power supply and to said rear light control.

10. The tail light assembly of claim 9, wherein said housing defines substantially a concave volume and said front perimeter thereof is circular.

11. The tail light assembly of claim 6, wherein said assembly comprises four said tail lights, two on each side of said rear light panel.

12. The tail light assembly of claim 11, wherein one of said tail lights on said each side of said rear light panel emits red light when being activated, to indicate braking of said vehicle.

13. The tail light assembly of claim 12, wherein one of said tail lights on said each side of said rear light panel emits white light when being activated, to indicate backing up of said vehicle.

14. The tail light assembly of claim 13, wherein at least one of said tail lights emits blinking white or red light when being activated, to indicate turning of said vehicle.

15. The tail light assembly of claim 6, wherein said assembly comprises six said tail lights, three on each side of said rear light panel.

16. The tail light assembly of claim 15, wherein one of said tail lights on said each side of said rear light panel emits red light when being activated, to indicate braking of said vehicle.

17. The tail light assembly of claim 16, wherein one of said tail lights on said each side of said rear light panel emits white light when being activated, to indicate backing up of said vehicle.

18. The tail light assembly of claim 17, wherein at least one of said tail lights emits yellow light when being activated, to indicate turning of said vehicle.
